(19) United States
(12) Patent Application Publication
(10) Pub. No.: US 2009/0202118 A1
(43) Pub. Date: Aug. 13, 2009

(54) Method and apparatus for wireless image guidance

(76) Inventor: Edward John Holupka, Meday, MA (US)

Correspondence Address: Edward J. Holupka, 5 Carriage House Way, Medway, MA, 02053, US

(21) Appl. No.: 12/315,420

(22) Filed: Dec. 3, 2008

Related U.S. Application Data
(60) Provisional application No. 61/012,327, filed on Dec. 7, 2007.

(51) Int. Cl. G06K 9/00

(52) U.S. Cl. 382/128

(57) ABSTRACT

A method of guiding a spatial procedure in a space comprises: a) obtaining spatial information in a first coordinate frame; b) transforming the obtained spatial information into a second coordinate frame; and c) indicating the transformed spatial information in the second coordinate frame. A system for guiding a spatial procedure in a space comprises: a) a first device configured to provide spatial information in a first coordinate frame; b) a second device configured to provide a second coordinate frame; and c) means for indicating the spatial information in the second coordinate frame. Computer software programs that can be used with the method and/or the system are also described herein.

### RELATED APPLICATION

This application claims the benefit of U.S. Provisional Application No. 61/012,327, filed on Dec. 7, 2007.

The entire teachings of the above application(s) are incorporated herein by reference.

### BACKGROUND OF THE INVENTION

Radiotherapy is an image-guided intervention, and imaging is involved in every key step of the process, ranging from patient staging, simulation, treatment planning, and radiation delivery, to patient follow-up. The evolution of radiation therapy has been strongly correlated with the development of imaging techniques. While all radiation therapy procedures are image guided per se, traditionally, imaging technology has primarily been used in producing three-dimensional (3D) scans of the patient's anatomy to identify the location of the tumor prior to treatment. New radiation planning, patient setup, and delivery procedures such as 3D conformal radiation therapy (3DCRT) and intensity-modulated radiation therapy (IMRT) that integrate cutting-edge image-based tumor definition methods, patient positioning devices, and/or radiation delivery guiding tools have been emerging. In current 3DCRT or IMRT or other image-guided therapy (IGT), uncertainties exist in many circumstances, such as tumor target definition, patient immobilization, and patient breathing motion, which make it difficult to administer a high radiation dose to the planned location. There is a need to reduce such uncertainties in image-guided radiation therapy.

### SUMMARY OF THE INVENTION

The present invention relates to wireless image-based guidance of a spatial procedure. Certain embodiments of the present invention find utility in the medical field and are related to wireless image-based guidance for certain medical procedures. Methods according to such embodiments can help reduce uncertainties in such medical procedures.

According to one embodiment of the present invention, a method of guiding a spatial procedure in a space comprises: a) obtaining spatial information in a first coordinate frame; b) transforming the obtained spatial information into a second coordinate frame; and c) indicating the transformed spatial information in the second coordinate frame. The method can further comprise generating the spatial information in the first coordinate frame. The method can also further comprise storing the obtained spatial information in the first coordinate frame before transforming the obtained spatial information into the second coordinate frame. The method can also further comprise providing the second coordinate frame. Indicating the transformed spatial information in the second coordinate frame can comprise displaying the transformed spatial information in the second coordinate frame.

According to another embodiment of the present invention, a method of guiding a spatial procedure in a space comprises: a) obtaining spatial information in a first coordinate frame within the space; b) transforming the obtained spatial information into a second coordinate frame; and c) indicating the transformed spatial information in the second coordinate frame, wherein the second coordinate frame is inherent to at least one device located within the space and provided by the at least one device located within the space through wireless communication in real-time. The Space can be within an object and the at least one device located within the space can be implemented into the object. Indicating the transformed spatial information in the second coordinate system can comprise displaying at least one image of at least part of the object and perhaps its surroundings and/or environment in real-time.

According to still another embodiment of the present invention, a method of guiding a spatial procedure in a patient comprises: a) obtaining spatial information in a first coordinate frame within the patient; b) transforming the obtained spatial information into a second coordinate frame; and c) indicating the transformed spatial information in the second coordinate frame. The second coordinate frame can be inherent to at least one device implanted within the patient and provided by the at least one device implanted within the patient through wireless communication in real-time. Indicating the transformed spatial information in the second coordinate frame can comprise displaying at least one image of at least part of the patient in real-time.

According to yet another embodiment of the present invention, a system for guiding a spatial procedure in a space comprises: a) a first device configured to provide spatial information in a first coordinate frame; b) a second device configured to provide a second coordinate frame; and c) means for indicating the spatial information in the second coordinate frame. The system can further comprise means for transforming the spatial information from the first coordinate frame into the second coordinate frame. The second device can be located in the space. The spatial information in the first coordinate frame can comprise an image. The spatial information indicated in the second coordinate frame can also comprise an image.

According to yet another embodiment of the present invention, a computer program product comprises a computer useable medium having a computer readable program. The computer readable program when executed on a computer causes the computer to: receive spatial information in a first coordinate frame within a space; transform the obtained spatial information into a second coordinate frame; and indicate the transformed spatial information in the second coordinate frame.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of two 3D coordinate graphs illustrating an example of a transformation between an image coordinate frame and a real-time coordinate frame of subject beacons according to one embodiment of the present invention.

FIG. 2 is an image illustrating an example of volume rendering as a method of visualization according to one embodiment of the present invention.

FIG. 3 is an image illustrating an example of projection rendering as a method of visualization according to one embodiment of the present invention.

FIG. 4 is a flow diagram of an exemplary software system according to one embodiment of the present invention.

FIG. 5 is a schematic view of a computer environment in which the principles of the present invention may be implemented.

FIG. 6 is a block diagram of the internal structure of a computer from the FIG. 5 computer environment.

### DETAILED DESCRIPTION OF THE INVENTION

A description of example embodiments of the invention follows.

The teachings of all patents, published applications and references cited herein are incorporated by reference in their entirety.

The present invention relates to the development of a system and a method for the wireless image based guidance of a spatial procedure in a space. As used herein, a “space” refers to any extent (area or room) in two dimensions or in three dimensions. A space need not be blank or hollow. Any material object may be located within a space, and any event may occur within a space. For example, a human body can be considered a space in which the different organs (objects) are located. As used herein, a “spatial procedure” can be any event occurring in a space as a result of human intervention. Preferably, a spatial procedure is performed on one or more objects within the space. For example, any medical procedure performed on a human body can be considered a spatial procedure. Certain spatial procedures, such as surgery, require accurate spatial information about the space and the objects contained therein, e.g., where exactly each organ and/or tumor is located in the body. Therefore, certain embodiments of the present invention relates to the development of a system and a method for the wireless image based guidance of a medical procedure. A description of example embodiments in medical applications is provided below. However, the present invention is not limited to the field of medicine. It will be understood by those skilled in the art that certain embodiments of the present invention can also find utility in other fields and industries such as geology, mining and space exploration, in which accurate spatial information is beneficial.

As used herein, “spatial information” refers not only to physical dimensions of a space (e.g., area, size, volume, shape or boundary of the space) and physical dimensions of any object within the space (e.g., area, size, volume, shape or boundary of the object), but also to spatial relationship of the space and/or any object within the space, such as the absolute and relative location of the space and any object within the space (e.g., location of an object in the space relative to the space, location of an object in the space relative to other object(s) in the same space, and location of the space relative to other space). A collection of integers, referred to herein as “a voxel” or “voxels,” which have a distinct spatial relationship between them is referred to herein as an “image.” The existence of a spatial relationship between the collection of integers necessitates the existence of a coordinate frame in which the spatial relationship can be referred to. For example, by determining the spatial information of each integer relative to a coordinate frame, the spatial relationship between all integers within a space can be determined, thereby an image can be determined. An example of such an image is the set of two-dimensional images obtained from a Computerized Axial Tomography, or CT, scanner. In such an image set, the integers take the form of gray scale or color values, and their positions in three-dimensional space are supplied by a defined coordinate frame native (i.e., inherent) to the physical properties of the CT scanner. As used herein, a device which can generate and/or supply an image of a space or any object within the space is referred to as “imaging device.” For example, the CT scanner can be thought of as an imaging device.

Spatial information, including images, can be transmitted, or communicated, between different objects. As used herein, a repeated communication of information between two or more objects is referred to as “real-time communication,” and a communication of information between two or more objects that does not require a physical connection between the objects is referred to as “wireless communication.” As referred to herein, a “system” is any means by which spatial and other information can be supplied via wireless communication. Various devices and infrastructures that can provide wireless communication are known to those skilled in the art. Typical prior art devices are camera-type devices that do not supply “spatial information” of the present invention but supply picture data only. The devices of the present invention can supply spatial information via wireless communication.

In the present invention, a system and an imaging device can be a same device, or incorporated or embedded in a same device. For example, wireless capsule endoscopy uses a capsule containing a color video camera and a wireless radio frequency transmitter to take color images during its journey through the digestive tract. In this case, the capsule is both an imaging device and a system to transmit the information contained in the images via wireless communication. Alternatively, a system can be different from an imaging device, but work in combination with an imaging device. For example, a system can transmit spatial information via wireless communication to an imaging device and the imaging device can analyze the spatial information received and generate an image based on the analysis. The analysis can comprise transformation of the spatial information from one coordinate frame into another coordinate frame. An example of the transformation of spatial information from one coordinate frame into another coordinate frame is given in detail below. The transformation can be carried out by any means known to those skilled in the art. Non-limiting examples of such means include any computer with proper algorithms and any human being with proper knowledge of the mathematics required to do the transformation. Examples of mathematical knowledge useful in carrying out the transformation are given in detail below.

The spatial information, either before transformation or after transformation, can be indicated in various ways. As used herein, “indicating” is referred to as making the spatial information known to any person skilled in the art by any human cognizable means. Non-limiting examples of such means of indicating include visual indication, for example, by displaying the spatial information in texts, images and/or videos, and audio indication, for example, by producing certain sound(s) and/or voice(s) that can audibly convey the spatial information. Screens, computer monitors or other screens, printers, speakers, and any other devices known in the art to function as an output device can be used as a means of indicating spatial information.

As used herein, any device that supplies real-time, wireless communication is referred to as a “beacon.” Preferably, the information communicated by a beacon comprises spatial information. An example of such a beacon is a seed implant in a patient, which can supply real-time communication containing spatial information (e.g., where in the patient's body the seed implant is located) via radiation, a form of wireless communication, as defined herein. In this case, the beacon becomes a system, as defined herein, with real-time communication capabilities. More preferably, a beacon has a coordinate frame that is native (i.e., inherent) thereto, so that any spatial information the beacon can generate and/or transmit can be referred to as relative to the coordinate frame native to the beacon.

One or more beacons can be placed (also referred to herein as “implanted”) into a space, wherein the space can comprise one or more objects. Preferably, an implanted beacon is rigid with respect to the space in which the beacon is implanted, i.e., the beacon does not move relative to the space. Alternatively, the beacon can be mobile relative to the space in which the beacon is implanted. An image of a space and/or the objects contained therein can be generated by an imaging device using spatial information transmitted from one or more beacons implanted in the space, i.e., spatial information generated by the one or more beacons implanted in the space can be transmitted by the one or more beacons to an imaging device for further processing, e.g., analyzing and displaying.

Let the integers associated with the voxels of the image be described

Iᵢ, 1≦i≦N_{I},

where N_{I} is the total number of voxels in the image.

Let the spatial position of the voxel described by Iᵢ of the image be described

\vec{r}ᵢ^{(I)}, 1≦i≦N_{I}.

The pair of values, (Iᵢ, \vec{r}ᵢ^{(I)}) is obtainable from the imaging device by definition of the image device. An example of such pairs are the gray scale or other color scale values and their spatial coordinates supplied by a CT scanner. In this example it is common to refer to the gray scale values in terms of a universally accepted standard definition called “Hounsfield Numbers”.

Optionally, the implanted beacons can be visible on the image. In this case, one or more voxels in the image can correspond to each implanted beacon. For example, if the material of which the beacons are made have an electron density that is in the range of a CT scanner, the resultant three-dimensional image obtained from the CT scanner can display the implanted beacons, or rather, the beacons can be visible on the CT image.

As described above, a beacon can have a coordinate frame inherent thereto, and an imaging device can have a coordinate frame inherent thereto. These two coordinate frames are not necessarily the same, and in practice, they are not the same in most cases. Therefore, there is a need to transform spatial information of the beacons from as referenced in one coordinate frame to the other, and vice versa.

Let the spatial position of the beacons as referenced to the coordinate frame of the image (inherent to the imaging device) be described by the vector notation

\vec{r}ᵢ^{(B)}, 1≦i≦N_{B}

where N_{B} is the number of implanted beacons. The vector position of the beacon(s) as seen on the image may be taken as the geometric center of the voxel or set of voxels which correspond to the beacon(s).

Let now the spatial position of an implanted beacon, which is supplied in real-time, be described as referenced to the coordinate frame inherent to the beacon

\vec{r}ᵢ^{(RT)}(t), 1≦i≦N_{B}

where t refers to the time the spatial information is transmitted.

For notational convenience define the terms the transformation matrix (also referred to herein as the “transformation”)

mᵢⱼ, 1≦i, j≦4

where the individual matrix elements are given by

m₁₁(t)=cos a(t)cos b(t)cos g(t)−sin a(t)sin g(t),

m₁₂(t)=sin a(t)cos b(t)cos g(t)+cos a(t)sin g(t),

m₁₃(t)=−sin a(t)cos g(t),

m₁₄(t)=tₓ(t),

m₂₁(t)=−cos a(t)cos b(t)sin g(t)−sin a(t)cos g(t)

m₂₂(t)=−sin a(t)cos b(t)sin g(t)−cos a(t)cos g(t)

m₂₃(t)=sin a(t)sin g(t),

m₂₄(t)=t_{y}(t),

m₃₁(t)=−cos a(t)sin b(t),

m₃₂(t)=sin a(t)sin b(t),

m₃₃(t)=cos b(t),

m₃₄(t)=t_{z}(t),

m₄₁(t)=tₓ(t),

m₄₂(t)=t_{y}(t),

m₄₃(t)=t_{z}(t),

m₄₄(t)=1.

The coordinate transformation from the Image coordinate frame into Real-Time Beacon coordinate frame is defined by

$$( \begin{matrix}{m}_{11} ( t ) & {m}_{12} ( t ) & {m}_{13} ( t ) & {m}_{14} ( t ) \\ {m}_{21} ( t ) & {m}_{22} ( t ) & {m}_{23} ( t ) & {m}_{24} ( t ) \\ {m}_{31} ( t ) & {m}_{32} ( t ) & {m}_{33} ( t ) & {m}_{34} ( t ) \\ {m}_{41} ( t ) & {m}_{42} ( t ) & {m}_{43} ( t ) & {m}_{44} ( t )\end{matrix} ) ( \begin{matrix}{x}_{i}^{( B )} \\ {y}_{i}^{( B )} \\ {z}_{i}^{( B )} \\ 1\end{matrix} ) = ( \begin{matrix}{x}_{i}^{( RT )} ( t ) \\ {y}_{i}^{( RT )} ( t ) \\ {z}_{i}^{( RT )} ( t ) \\ 1\end{matrix} ) ,$$

where

$${\vec{r}}_{i}^{( RT )} ( t ) = ( \begin{matrix}{x}_{i}^{( RT )} ( t ) \\ {y}_{i}^{( RT )} ( t ) \\ {z}_{i}^{( RT )} ( t ) \\ 1\end{matrix} ) , 1 \leq i \leq {N}_{B} , \\ {\vec{r}}_{i}^{( B )} = ( \begin{matrix}{x}_{i}^{( B )} \\ {y}_{i}^{( B )} \\ {z}_{i}^{( B )}\end{matrix} ) , 1 \leq i \leq {N}_{B} , \\ \vec{t} = ( \begin{matrix}{t}_{x} \\ {t}_{y} \\ {z}_{z}\end{matrix} ) , 1 \leq i \leq {N}_{B} ,$$

\vec{t} is the vector translation and (a(t), b(t), g(t)) are the Euler angles which relate the coordinate frame of the beacons to the coordinate frame of the image.

It is convenient to define the nine values for the transformation

(sin a(t),sin b(t),sin g(t),cos a(t),cos b(t),cos g(t),tₓ(t),t_{y}(t),t_{z}(t)),

in which case a minimum of three beacons are needed to be implanted. These nine values for the transformation can be uniquely determined given the following

$$( {x}_{i}^{( B )} , {x}_{i}^{( RT )} ) , ( {y}_{i}^{( B )} , {y}_{i}^{( RT )} ) ( {z}_{i}^{( B )} , {z}_{i}^{( RT )} ) , \\ ( {x}_{j}^{( B )} , {x}_{j}^{( RT )} ) , ( {y}_{j}^{( B )} , {y}_{j}^{( RT )} ) ( {z}_{j}^{( B )} , {z}_{j}^{( RT )} ) , \\ ( {x}_{k}^{( B )} , {x}_{k}^{( RT )} ) , ( {y}_{k}^{( B )} , {y}_{k}^{( RT )} ) ( {z}_{k}^{( B )} , {z}_{k}^{( RT )} ) , \\ i \neq j \neq k .$$

Once the transformation from the image coordinate frame to the real-time beacon coordinate frame is known, the inverse transformation from the real-time beacon coordinate frame to the image coordinate frame can be easily calculated by taking the inverse of mᵢⱼ, or

$${( \begin{matrix}{m}_{11} ( t ) & {m}_{12} ( t ) & {m}_{13} ( t ) & {m}_{14} ( t ) \\ {m}_{21} ( t ) & {m}_{22} ( t ) & {m}_{23} ( t ) & {m}_{24} ( t ) \\ {m}_{31} ( t ) & {m}_{32} ( t ) & {m}_{33} ( t ) & {m}_{34} ( t ) \\ {m}_{41} ( t ) & {m}_{42} ( t ) & {m}_{43} ( t ) & {m}_{44} ( t )\end{matrix} )}^{- 1} ( \begin{matrix}{x}_{i}^{( RT )} ( t ) \\ {y}_{i}^{( RT )} ( t ) \\ {z}_{i}^{( RT )} ( t ) \\ 1\end{matrix} ) = ( \begin{matrix}{x}_{i}^{( B )} ( t ) \\ {y}_{i}^{( B )} ( t ) \\ {z}_{i}^{( B )} ( t ) \\ 1\end{matrix} ) ,$$

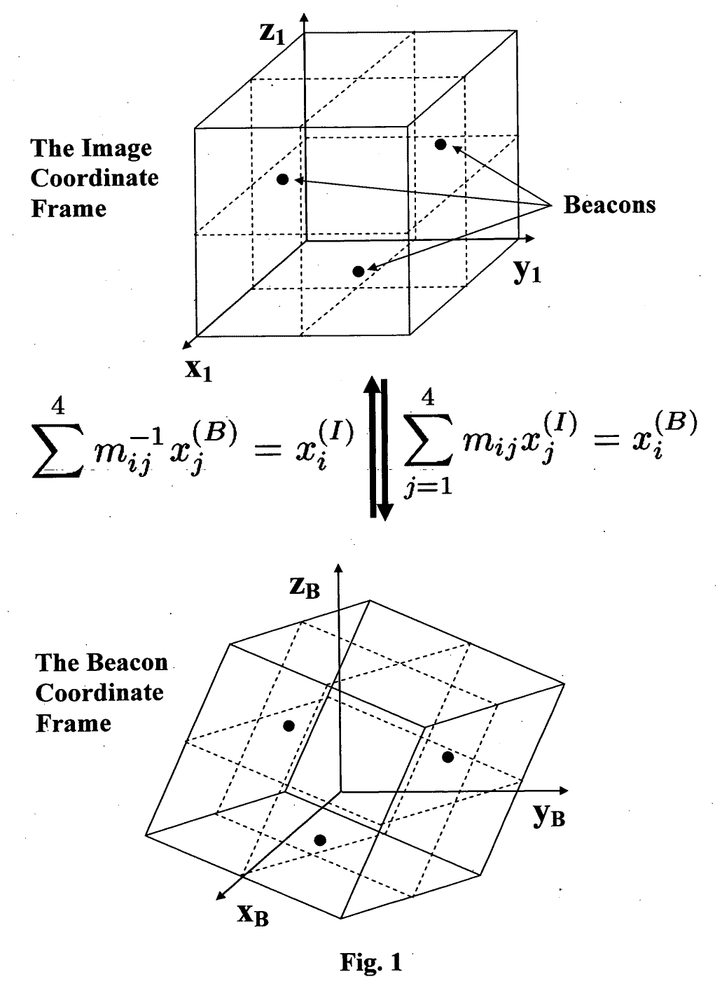

The transformation and it's inverse can be calculated in a number of ways, all of which are standard algorithms known to those skilled in the art. A graphic description of the real-time transformation of the image into the coordinate frame of the beacons is given in FIG. 1.

Once these six (or nine) values for the transformation are determined in real-time, any voxel in the image can be transformed into the coordinate frame of the beacons also in real-time. Any information associated with the image can also be transformed into the coordinate frame of the beacons in real-time. Any voxel in the image can then be transformed into the real-time coordinate frame of the beacons by utilizing the formula

$$( \begin{matrix}{m}_{11} ( t ) & {m}_{12} ( t ) & {m}_{13} ( t ) & {m}_{14} ( t ) \\ {m}_{21} ( t ) & {m}_{22} ( t ) & {m}_{23} ( t ) & {m}_{24} ( t ) \\ {m}_{31} ( t ) & {m}_{32} ( t ) & {m}_{33} ( t ) & {m}_{34} ( t ) \\ {m}_{41} ( t ) & {m}_{42} ( t ) & {m}_{43} ( t ) & {m}_{44} ( t )\end{matrix} ) ( \begin{matrix}{x}_{i}^{( I )} \\ {y}_{i}^{( I )} \\ {z}_{i}^{( I )} \\ 1\end{matrix} ) = ( \begin{matrix}{x}_{i}^{( I , RT )} ( t ) \\ {y}_{i}^{( I , RT )} ( t ) \\ {z}_{i}^{( I , RT )} ( t ) \\ 1\end{matrix} ) , 1 \leq i \leq {N}_{I} . ,$$

Once the image has been transformed into the real-time coordinate frame of the beacons the resultant transformed image can be visualized in real-time in a number of different ways. Two exemplary different visualization methods are described below. However, the real-time image can be represented in ways other than described here.

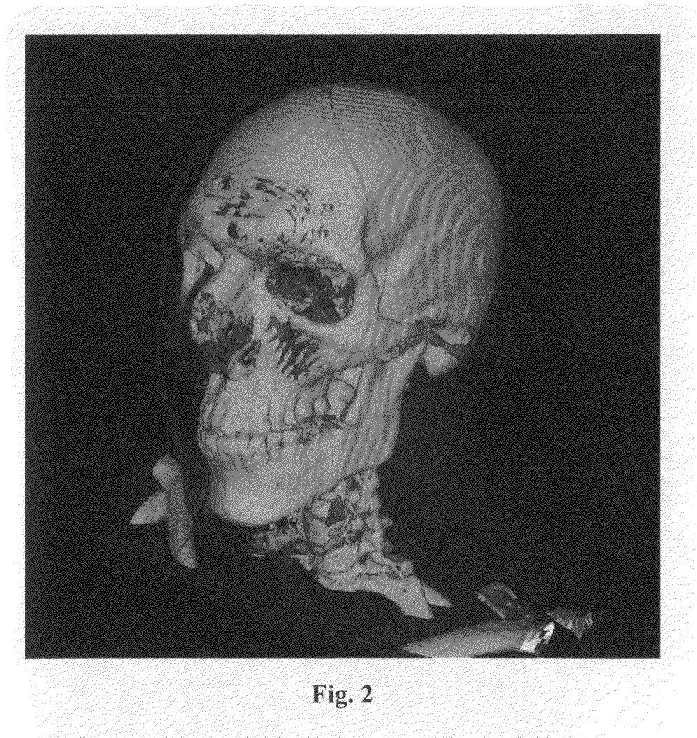

(i) Three-dimensional volume rendering: the transformed real-time image can be volume rendered to enhance specific regions of the image. For example, if the image is a CT scan, the resultant, transformed real-time image could be rendered in three-dimensions to only display the bony tissues. Similarly, the resultant, transformed real-time image could be rendered in three-dimensions to only display user specified soft tissue structures. These structures, whether bony or otherwise, could be defined on the original, untransformed image by a user, and these specific structures could be selectively rendered in real-time in the beacon coordinate frame using structure specific colors chosen by a user. FIG. 2 displays a sample three-dimensional image which is the result of selectively volume rendering the image data from the Visible Human Project, a government based project which makes available to the public image data of a human male and female.

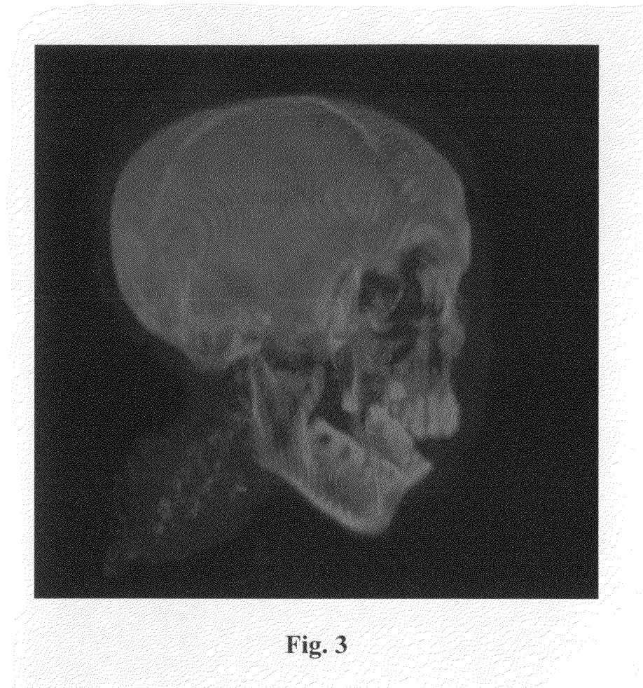

(ii) Two-dimensional projection rendering: the transformed real-time image can be projected from a user specified angle and position from within the transformed image which will result in a two-dimensional image. This would result in a two-dimensional image which would resemble an x-ray of the transformed real-time image. For example, if the image is a CT scan, the resultant transformed image could be rendered as a conventional x-ray without the use of additional radiation to the subject. An example of such a two-dimensional projection image is displayed in FIG. 3.

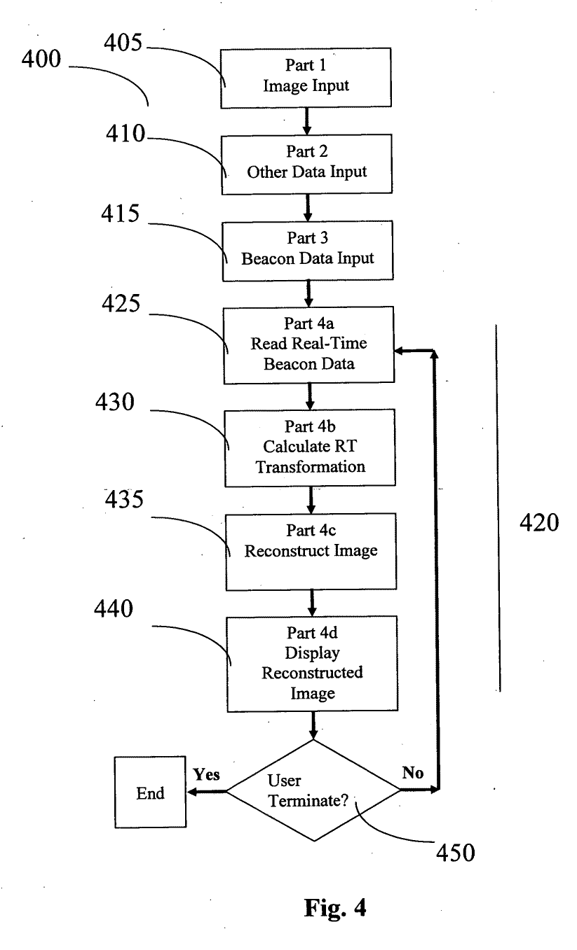

The described system for wireless image guidance can be realized through computer processor routines or program software or the like. FIG. 4 is a block diagram showing an exemplary computer-based system 400 according to one embodiment of the present invention. In this example, the computer-based system is developed in four basic parts. In the first part (“Part 1”; 405), the image data is communicated to the invention system through any available means, such as direct connection to the imaging device, network communication, or DICOM network transfer. The image data may also be read in from any storage medium, such as hard disk memory or removable memory. This part of the invention system is referred to as “Image Input”.

Once the image data is communicated to the system 400, any other data such as Volumes of Interest (VOI's), or any data calculated from the image can be communicated to the system 400. This part (“Part 2”; 410) of the invention system 400 is referred to as the “Other Data Input”.

In the next part (“Part 3”; 415) of the invention system 400, the spatial coordinate information of implanted beacon(s) is communicated to the system 400. The beacon data could be communicated as part of the Other Data Input. However, it can also be communicated separately. This part of the invention system 400 is referred to as “Beacon Data Input”.

Part 1, Part 2, and Part 3 are executed any time after the acquisition of the image. Once executed, the invention system 400 stores the image and all communicated data received in Part 1, Part 2, and Part 3 in any format and any medium. This stored data is accessed at a later date when one wishes to reconstruct this data in real-time.

The next part 420 of the invention system 400 allows a person using the system to select the mode in which the reconstructed data in real-time can be viewed. The modes can be, but are not limited to the two examples stated in connection with FIGS. 2 and 3. In such a way, previously acquired image data can be later used and reconstructed and visualized in real-time using the subsequent parts of the software system. However, it is noted that the parts of the invention system described below are only exemplary and the present invention is not limited to reconstruction and visualization of previously acquired image data using the methods described below.

In 420 the invention system 400 begins an infinite repetition of steps, referred to herein as the “loop”. This repetition of steps can be terminated at a user's request 450. In the loop the invention system first obtains the three-dimensional, real-time spatial coordinates of all implanted beacons (“Part 4a”; 425) referred to as “Read Real-Time Beacon Data” in FIG. 4. In the next part (“Part 4b”; 430) the invention system 400 calculates a transformation, mᵢⱼ(t), referred to as “Calculate RT Transformation” in FIG. 4. In the next part (“Part 4c”; 435) of the loop 420, the invention system 400 reconstructs the image (“Reconstructed Image”) in the user-selected mode of visualization (“Visualization Mode”). This real-time reconstruction is based on the calculation of the transformation. In the next part (“Part 4d”; 440), the invention system 400 displays the reconstructed image. Displaying the reconstructed image can end the loop 420. Alternatively, processes Part 4a, Part 4b, Part 4c, and Part 4d can be repeated until the user specifies the system to stop 450.

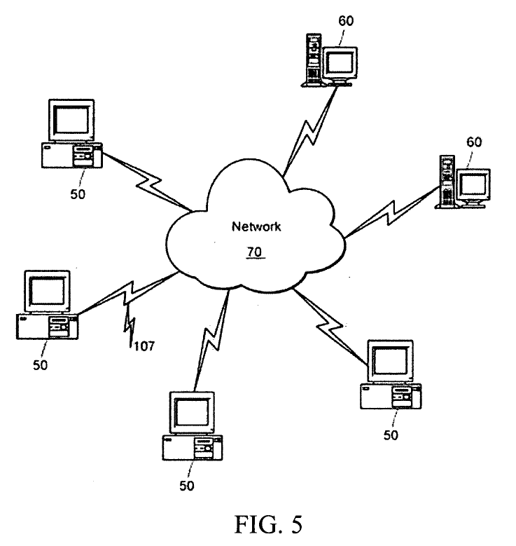

FIG. 5 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, Wi-Fi etc.) to communicate with one another. Other electronic device/computer network architectures are suitable.

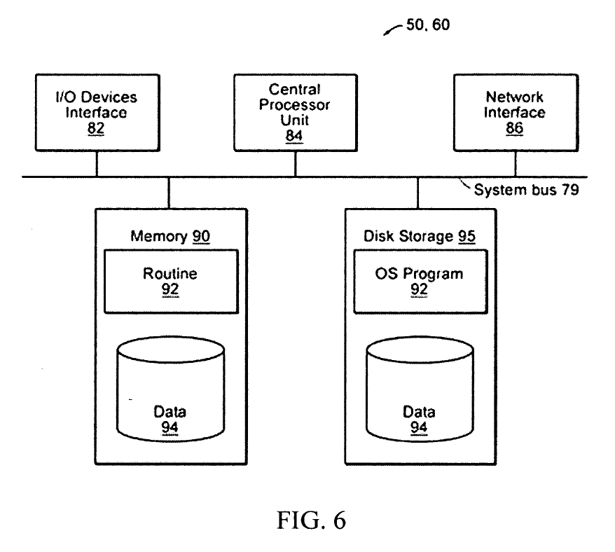

FIG. 6 is a diagram of the internal structure of a computer (e.g., client processor/device 50 or server computers 60) in the computer system of FIG. 5. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, volatile memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 7). Volatile memory 90 provides volatile storage for computer software instructions 92 and data 94 used to implement an embodiment of the present invention (e.g., the invention system detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 (see FIG. 5) embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

The present invention may be implemented in a variety of device architectures. The computer network of FIGS. 5 and 6 are for purposes of illustration and not limitation of the present invention.

While this invention has been particularly shown and described with references to example embodiments thereof, it will be understood by those skilled in the art that various changes in form and details may be made therein without departing from the scope of the invention encompassed by the appended claims.

What is claimed is:

1. A method of guiding a spatial procedure in a space, comprising:
a) obtaining spatial information in a first coordinate frame;
b) transforming the obtained spatial information into a second coordinate frame; and
c) indicating the transformed spatial information in the second coordinate frame.

2. The method of claim 1, further comprising generating the spatial information in the first coordinate frame.

3. The method of claim 2, wherein generating the spatial information in the first coordinate frame comprises generating the spatial information in the first coordinate system using an imaging device.

4. The method of claim 3, wherein the spatial information in the first coordinate frame comprises an image.

5. The method of claim 3, wherein the first coordinate frame is inherent to the imaging device.

6. The method of claim 1, further comprising storing the obtained spatial information in the first coordinate frame before transforming the obtained spatial information into the second coordinate frame.

7. The method of claim 1, further comprising providing the second coordinate frame.

8. The method of claim 7, wherein providing the second coordinate frame comprises providing the second coordinate frame in real-time using at least one device located within the space.

9. The method of claim 8, wherein providing the second coordinate frame comprises providing the second coordinate frame in real-time using at least three devices located within the space.

10. The method of claim 8, wherein the second coordinate frame is inherent to the at least one device located within the space.

11. The method of claim 8, wherein the second coordinate frame is provided in real-time by the at least one device located within the space through wireless communication.

12. The method of claim 1, wherein indicating the transformed spatial information in the second coordinate frame comprises displaying the transformed spatial information in the second coordinate frame.

13. The method of claim 12, wherein displaying the transformed spatial information in the second coordinate frame comprises displaying at least one image.

14. The method of claim 13, wherein displaying the at least one image comprises displaying at least one three-dimensional image.

15. The method of claim 13, wherein displaying the at least one image comprises displaying at least one two-dimensional image.

16. A system for guiding a spatial procedure in a space, comprising:
a) a first device configured to provide spatial information in a first coordinate frame;
b) a second device configured to provide a second coordinate frame; and
c) means for indicating the spatial information in the second coordinate frame.

17. The system of claim 16, further comprising means for transforming the spatial information from the first coordinate frame into the second coordinate frame.

18. The system of claim 16, wherein the second device is located in the space.

19. The system of claim 16, wherein the spatial information in the first coordinate frame comprises an image.

20. The system of claim 19, wherein the second device is visible on the image.

21. The system of claim 16, wherein the spatial information indicated in the second coordinate frame comprises an image.

22. The system of claim 21, wherein the image is a three-dimensional image.

23. The system of claim 21, wherein the image is a two-dimensional image.

24. A computer program product comprising a computer useable medium having a computer readable program, wherein the computer readable program when executed on a computer causes the computer to:
receive spatial information in a first coordinate frame;
transform the obtained spatial information into a second coordinate frame; and
indicate the transformed spatial information in the second coordinate frame.
